(19) United States
(12) Patent Application Publication
(10) Pub. No.: US 2015/0118428 A1
(43) Pub. Date: Apr. 30, 2015

(54) SELF LUBRICATED CPVC RESIN WITH IMPROVED PROPERTIES

(71) Applicant: Lubrizol Advanced Materials, Inc., Cleveland, OH (US)

(72) Inventors: Christopher D. Zook, Akron, OH (US); Robert G. Vielhaber, Avon, OH (US)

(73) Assignee: Lubrizol Advanced Materials, Inc., Cleveland, OH (US)

(21) Appl. No.: 14/397,949

(22) PCT Filed: May 1, 2013
(86) PCT No.: PCT/US2013/039004

§ 371 Date: Oct. 30, 2014

Related U.S. Application Data
(60) Provisional application No. 61/640,741, filed on May 1, 2012.

(51) Int. Cl. C08F 214/06; B32B 1/08

(52) U.S. Cl. CPC C08F 214/06; B32B 1/08
USPC 428/36.9; 526/344

(57) ABSTRACT

The disclosed technology relates to a compound suitable for preparing articles, such as pipe, with good physical properties, such as impact strength, and resistance to environmental stress cracking (ESC). In particular, the technology relates to a vinyl chloride copolymer resin, such as chlorinated polyvinyl chloride or polyvinyl chloride, herein collectively referred to as CPVC that maintains suitable processability at molecular weights above which other vinyl chloride polymer resins will not flow. Furthermore, the invention relates to vinyl chloride copolymer compounds containing the vinyl chloride polymer resin, and articles made from such compounds, which compounds meet 23447 cell classifications under ASTM D1784.

### BACKGROUND OF THE INVENTION

The disclosed technology relates to a plastic compound suitable for preparing articles, such as pipe, with good physical properties, such as impact strength, and resistance to environmental stress cracking (ESC). In particular, the technology relates to a vinyl chloride copolymer resin, which includes chlorinated polyvinyl chloride copolymer and polyvinyl chloride copolymer that maintains suitable processability at molecular weights above which vinyl chloride homo-polymer resins flow with difficulty or will not fuse. Furthermore, the invention relates to vinyl chloride copolymer compounds containing the vinyl chloride copolymer resin, and articles made from such compounds, which compounds meet 23447 cell classifications under ASTM D1784.

Polyvinyl chloride (PVC) is a vinyl chloride polymer having about 57 mol % chlorine bound along a polymerized ethylene backbone. Chlorinated polyvinyl chloride (CPVC) is a post-chlorinated form of PVC typically having greater than 57 mol % bound chlorine. CPVC is known to have excellent high temperature performance characteristics, among other desirable physical properties.

CPVC is an important specialty polymer due to its high glass transition temperature, high heat deflection temperature, outstanding flame and smoke properties and chemical inertness. While the glass transition temperature of the CPVC generally increases as the amount of chlorine increases, increased chlorine content causes the CPVC to become more difficult to process and products made therefrom to become more brittle. In this regard, it is known that CPVC resins generally have low impact properties and often require compounding with impact modifiers.

It is also known that CPVC resins are subject to environmental stress cracking. Many polymeric materials, loaded mechanically and immersed in certain kinds of liquids, undergo failures by crazing and/or cracking. The loads required are much less than those required of failures in air. The failure promoting liquids are non-solvents and chemically inert for polymers. Failures like these are called environmental stress crazing (ESCR), environmental stress cracking (ESC), and environmental stress failure (ESF) which includes both.

In simple terms, ESC occurs from an external or internal crack in a plastic caused by tensile stresses less than the plastic's short term mechanical strength, resulting in failure. The addition of an organic liquid (the environment) with the applied stress can result in ESC failures. In essence, the organic liquid wets the surface of the polymer and in combination with the tensile stress, accelerates the failure rate. This phenomenon was identified as far back as the 1940s in the general thermoplastics field.

Currently in the field of CPVC pipe, recommendations are in place on construction practices that will limit contact of the CPVC pipe with incompatible materials. However, a more fundamental approach for improving the resistance to ESC for CPVC articles is desired.

Higher Mw polymers are difficult, if not impossible to process into useful final products. In particular, compound made from standard CPVC resin either flows with difficulty or will not fuse properly at high Mw, for example, of much greater than 150,000 daltons, without levels of lubricant that negatively affect other properties of the final product, such as impact strength.

It has been taught that compounds comprised of chlorinated PVC-ethylene copolymers can be employed to produce optically clear final products, such as pipe, for example, as taught in U.S. Pat. No. 7,943,691 to Shakir et al., issued May 17, 2011. These copolymers are only taught to be employed at molecular weights of up to 150,000, and there is no discussion of the impact properties or resistance to ESC of the compounds. In fact, the general state of the art would have led those of ordinary skill desiring to extrude optically clear CPVC compounds according to the '691 patent to ensure the molecular weight of the resin taught in the '691 patent did not approach, let alone exceed 150,000 daltons.

A CPVC resin that can be readily processed and that can be employed in a CPVC compound to produce a final product having improved resistance to environmental stress cracking, with at least maintained or improved impact strength over traditional CPVC compounds, and meeting cell class 23447 under ASTM D1784 would be desirable.

### SUMMARY OF THE INVENTION

Surprisingly, the inventors have discovered that vinyl chloride copolymer resins, in particular CPVC-vinyl copolymer resins, having weight average molecular weights of greater than about 150,000 daltons can maintain suitable processability at molecular weights above which vinyl chloride homo-polymer resins either flow with difficulty or do not fuse properly. Even more surprising and contrary to expectation, compounds employing such resins provide impact strength at least equivalent, and often improved over that provided by standard (molecular weight below 150,000) vinyl chloride compounds. Likewise, the compounds employing such resins exhibit much improved chemical stability over standard vinyl chloride compounds.

Thus, one aspect of the invention relates to a new vinyl chloride or chlorinated vinyl chloride copolymer resin. The (chlorinated) vinyl chloride copolymer resin comprises a major portion of vinyl chloride monomer and a minor portion of a co-monomer selected from, for example, ethylene, propylene, and isobutylene, or mixtures thereof. The (chlorinated) vinyl chloride copolymer resin has a weight average molecular weight of greater than 150,000 daltons.

In certain embodiments of the (chlorinated) vinyl chloride copolymer resin, the co-monomer can be present at from about 0.01% to about 10% of the total monomers in the (chlorinated) vinyl chloride copolymer resin. Likewise, in certain embodiments, the (chlorinated) vinyl chloride copolymer resin can have a chlorine content of between about 57 wt. % and 70 wt. %, and preferably the (chlorinated) vinyl chloride copolymer resin can be a UV-chlorinated resin.

In another aspect of the invention, there is provided a (chlorinated) vinyl chloride copolymer compound comprising the (chlorinated) vinyl chloride copolymer resin described above.

In one embodiment of the (chlorinated) vinyl chloride copolymer compound, the (chlorinated) vinyl chloride copolymer resin can be present at about from 78 wt. % to about 92 wt. % of the total compound.

In another embodiment, the (chlorinated) vinyl chloride copolymer compound can additionally comprise a low weight average molecular weight (Mw) (chlorinated) vinyl chloride (co)polymer resin having an Mw of less than 150,000 daltons in a blend with the (chlorinated) vinyl chloride copolymer resin, and wherein the average Mw of the resin blend is greater than 150,000 daltons.

A further aspect of the invention relates to articles, such as pipe, pipe fittings, and valves, made from the above (chlorinated) vinyl chloride copolymer compound, which incorporates the (chlorinated) vinyl chloride copolymer resin.

In a further aspect of the invention, there is provided a method of imparting processability to a (chlorinated) vinyl chloride copolymer resin having an Mw of greater than 150,000 daltons. The method comprises preparing the (chlorinated) vinyl chloride copolymer resin from vinyl chloride co-monomer and ethylene co-monomer.

An additional aspect of the invention relates to a method of providing an article having improved chemical stability compared to the same article prepared from CPVC compound having an Mw of less than 150,000 daltons. The method comprises employing in the CPVC compound at least 78 wt. % of the (chlorinated) vinyl chloride copolymer resin as described above.

### DETAILED DESCRIPTION OF THE INVENTION

Various preferred features and embodiments will be described below by way of non-limiting illustration.

One aspect of the present invention is a vinyl chloride copolymer resin. Copolymer, or polymers as a case may be, are derived from the successive “linking” of monomers in a polymerization reaction. By linking, it is meant that the monomers become bonded together. The linking of monomers requires alteration of the chemical structures of the monomers for the purpose of freeing a bond the monomers can use to link by.

For example, the chemical structure of ethylene monomer is two CH₂ units connected by a double bond;

H₂C═CH₂.

When ethylene monomers are polymerized, or linked, the double bond is opened and becomes free to bond with another ethylene monomer;

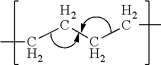

or otherwise represented as a repeating unit;

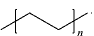

As can be seen, the repeating polyethylene unit is different from the starting ethylene monomer in that the double bond of the ethylene monomer has been opened. Although the polyethylene repeat unit is altered from the ethylene monomer from which it was derived, it is a common practice in the art of polymer plastics to refer to the repeating units of the polymer by the same name as the monomer. So, ethylene monomer refers both to CH₂═CH₂ and the polymerized repeat unit —[CH₂-CH₂]ₙ—, where n is the number of repeat units in the polymer. Likewise, ethylene units or blocks of ethylene in the polymer means units or blocks derived from ethylene monomer. Similarly, styrene units or blocks of styrene in the polymer means units or blocks derived from styrene monomer, and so on for other types of monomers.

Those of ordinary skill in the art recognize that the polymerized monomer will be of altered chemical structure, but understand the relation between the repeat unit and the monomer from which the repeat unit was derived. Thus, as used in the description below and in the claims, monomer will refer both to a repeat unit of a polymer derived from the monomer, as well as the stand-alone monomer itself.

Accordingly, vinyl chloride monomer refers both to vinyl chloride monomer and the repeat unit derived from vinyl chloride monomer:

| Vinyl chloride | Repeat unit derived from vinyl chloride |
|---|---|
| monomer | monomer |
| 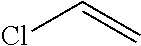 | 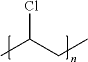 |

The vinyl chloride copolymer resin of the first aspect of the invention can comprise a major portion of vinyl chloride co-monomer and a minor portion of a vinyl component co-monomer. In addition, the vinyl chloride copolymer resin can have a weight average molecular weight of greater than about 150,000 daltons.

In one embodiment, from about 90% to about 99.99% of the co-monomers in the vinyl chloride copolymer resin can be vinyl chloride monomers, and preferably from about 91%, or 92% to about 99.9%, or 99.5% vinyl chloride monomers. In certain embodiments, the co-monomers in the vinyl chloride copolymer resin can be from about 93%, or 94% to 99% vinyl chloride monomers, and often from about 95% to 98% vinyl chloride monomers.

The remainder of the co-monomers in the vinyl chloride copolymer resin can be one or more vinyl component co-monomers, or mixtures thereof. That is, from about 0.01% to about 10% of the co-monomers in the vinyl chloride copolymer resin can be vinyl component monomers, or from about 0.1%, or 0.5% to about 9%, or 8% vinyl component monomers. In certain embodiments, the vinyl component co-monomer can be from about 1% to about 6%, or 7%, or more preferably, from about 2% to about 5% of the total co-monomers in the vinyl chloride copolymer resin.

By the term “vinyl component co-monomer” it is meant a vinyl type monomer other than vinyl chloride. Such monomers are well known to the art and to the literature and include esters of acrylic acid wherein the ester portion has from 1 to 12 carbon atoms, for example, methyl acrylate, ethyl acrylate, butyl acrylate, octyl acrylate, cyanoethyl acrylate, and the like; vinyl acetate; and vinyl aliphatic esters containing from 3 to 18 carbon atoms; esters of methacrylic acid wherein the ester portion has from to 12 carbon atoms, such as methyl methacrylate, ethyl methacrylate, butyl methacrylate, and the like; styrene and styrene derivatives having a total of from 8 to 15 carbon atoms such as alpha-methylstyrene, vinyl toluene, chlorostyrene; vinyl naphthalene; diolefins having a total of from 4 to 8 carbon atoms such as butadiene, isoprene, and including halogenated diolefins such as chloroprene; monoolefins having from 2 to 10 carbon atoms and preferably 2 to 4 carbon atoms such as ethylene, propylene and isobutylene; and mixtures of any of the above types of monomers and other vinyl monomers co-polymerizable therewith known to the art and to the literature. In a preferred embodiment, the vinyl component co-monomer can be ethylene, propylene or isobutylene, and most preferably, ethylene.

The vinyl chloride copolymer resin can be polymerized according to known polymerization methods. In one embodiment, the vinyl chloride copolymer resin may be post-chlorinated, that is, chlorinated after polymerization of the vinyl chloride co-monomer and vinyl component co-monomer. Post-chlorinated, or simply chlorinated vinyl chloride copolymer resin can conveniently be made by the chlorination of vinyl chloride copolymer by any one of several available methods including a solution process, a fluidized bed process, a photo-slurry process, a thermal process or a liquid chlorine process. Examples of these processes can be found in U.S. Pat. Nos. 2,996,489; 3,100,762; 4,412,898; 3,532,612; 3,506,637; 3,534,013; 3,591,571; 4,049,517; 4,350,798; and 4,377,459. In a preferred embodiment, chlorinated vinyl chloride copolymer resin can be made by a UV chlorination process, i.e., the chlorinated vinyl chloride is a UV-chlorinated resin. Likewise, in a preferred embodiment, no swelling agent is employed when chlorinating the resin.

The vinyl chloride copolymer resin may be post-chlorinated to a chlorine level of from between about 57 wt. % to about 70 wt. %. Preferably, the vinyl chloride copolymer resin can be chlorinated from between about 60 wt. % and 69 wt. %, more preferably from between about 63 wt. % and 68 wt. %, and most preferably from between about 66 wt. % and 67 wt. %. It is to be appreciated that where the vinyl chloride copolymer is post-chlorinated, both co-monomers in the copolymer will be affected, thereby reducing the measurable amount of vinyl component co-monomer. Thus, reference to the amount of co-monomer in the resin is done on a basis of non-post-chlorination.

The (chlorinated) vinyl chloride copolymer resin can be employed in a (chlorinated) vinyl chloride copolymer compound, prepared, for example, according to the methods taught in the “Encyclopedia of PVC,” Second Edition; Leondard I. Nass, Charles A. Heiberger or the “PVC Handbook,” Charles E. Wilkes, James W. Summers, Charles Anthony Daniels, Mark T. Berard. As used herein, reference to “(chlorinated)” means the material encompasses both non-post-chlorinated and post-chlorinated embodiments.

In one embodiment, the (chlorinated) vinyl chloride copolymer compound can contain the (chlorinated) vinyl chloride copolymer resin from about 78 wt. % to about 92 wt. % of the total (chlorinated) vinyl chloride copolymer compound. In another embodiment, the (chlorinated) vinyl chloride copolymer compound can contain the (chlorinated) vinyl chloride copolymer resin from about 82 wt. % to about 88 wt. %, and in another embodiment from about 84 wt. % to about 86 wt. % of the total (chlorinated) vinyl chloride copolymer compound.

The (chlorinated) vinyl chloride copolymer compound can additionally include (chlorinated) vinyl chloride polymer or copolymer resin having an Mw of less than 150,000 daltons. In such an embodiment, the average Mw of the blended resins in the compound will be greater than 150,000 daltons. The (chlorinated) vinyl chloride polymer or copolymer resin of less than 150,000 daltons herein is referred to as low Mw (chlorinated) vinyl chloride (co)polymer resin. Preferably, the (chlorinated) vinyl chloride copolymer compound will contain little to no low Mw (chlorinated) vinyl chloride (co)polymer resin. However, in some embodiments, the vinyl chloride copolymer compound can contain a ratio of greater than about 1:4 or 1:3 (chlorinated) vinyl chloride copolymer resin to low Mw (chlorinated) vinyl chloride (co)polymer resin. In some embodiments, the (chlorinated) vinyl chloride copolymer compound can contain a ratio of greater than about 1:2 or 1:1 (chlorinated) vinyl chloride copolymer resin to low Mw (chlorinated) vinyl chloride (co)polymer resin. Often the ratio of (chlorinated) vinyl chloride copolymer resin to low Mw (chlorinated) vinyl chloride (co)polymer resin can be from about 1:4 to about 4:1. As with the term “(chlorinated)”, the term “(co)” in (co)polymer means the polymer encompasses both homopolymers and copolymers.

The (chlorinated) vinyl chloride copolymer compound can additionally comprise other additives, such as those taught in the “Encyclopedia of PVC,” Second Edition; Leondard I. Nass, Charles A. Heiberger or the “PVC Handbook,” Charles E. Wilkes, James W. Summers, Charles Anthony Daniels, Mark T. Berard. For example, the (chlorinated) vinyl chloride copolymer compound can additionally comprise additives such as lubricants, impact modifiers, heat stabilizers or any other conventional additive. Ordinarily, a small amount of another resin or rubber, e.g., chlorinated polyethylene, styrene-acrylonitrile copolymer, or chlorinated isobutylene is blended with CPVC resin to improve its shock resistance and mechanical processability, and such additives are contemplated for the (chlorinated) vinyl chloride copolymer compound. Pigments, stabilizers, fillers, colorants, UV-stabilizers, and other processing aids, as well as other additives such as biocides or flame retardants, and any other plastic additive can also be incorporated in the (chlorinated) vinyl chloride copolymer compound.

The (chlorinated) vinyl chloride copolymer compound can be processed into an article by generally accepted methods. For example, the (chlorinated) vinyl chloride copolymer compound can be molded, extruded, extruded and machined, or processed by any other known method.

In a preferred embodiment, the (chlorinated) vinyl chloride copolymer compound can be processed into pipe, pipe fittings, and valves, with particular utility in the production of hot water piping for industrial and domestic use. The (chlorinated) vinyl chloride copolymer compound can also be employed, for example, to produce building products, such as siding, fencing or fenestration products, irrigation products, pool and spa products, electrical application products, HVAC application products, furniture, and as drawn sheets for custom applications. In addition, the (chlorinated) vinyl chloride copolymer compound can be useful in the rigid vinyl field for the manufacture of other articles, such as, for example, ductwork, tanks, appliance parts, etc., especially where the products will handle or contact hot water and other hot or corrosive liquids.

The (chlorinated) vinyl chloride copolymer compound when properly extruded and formed desirably meets or exceeds the requirements of ASTM D 1784 cell class 23447 and provides long term performance and reliability, including a high degree of safety over continuous use. The first numeral “2” in the cell class specifies CPVC pipe; the second numeral (whether “3” or “4”) specifies the level of notched Izod impact strength (“3” indicates at least 80.1 J/m (1.5 ft.lb/in) of notch, “4” indicates at least 266.9 J/m (5 ft.lb/in) of notch); the third numeral “4” specifies tensile strength of at least 48.3 MPa (7,000 psi); the fourth numeral “4” specifies tensile modulus of at least 2482 MPa (360,000 psi); and the fifth numeral “7” specifies the level of distortion temperature under load (DTUL) or heat deflection temperature (HDT) measured under 1.82 MPa (264 psi) load. Numeral “7” indicates DTUL or HDT of at least 100° C. (see ASTM D1784).

One aspect of the present invention is a (chlorinated) vinyl chloride copolymer resin that flows or fuses at Mws greater than can be achieved by standard (chlorinated) vinyl chloride homo-polymer resin. For example, including the (chlorinated) vinyl chloride copolymer resins in a CPVC or PVC compound can maintain acceptable dynamic thermal stability torque (DTS-torque) for the compound compared to a CPVC or PVC compound of a homopolymer of the same Mw as the copolymer. DTS-torque of the compound can be one measure of the flow of the compound including the resin during processing, such as melt-extrusion. DTS-torque characterizes the level of torque required to mix the compound once the resin fuses. The lower the DTS-torque, the more processable the compound. Preferably, the DTS-torque can be less than 3600 meter-grams (m·g) as measured according to ASTM D-2538, or less than 3500 m·g, or less than 3400 m·g when the (chlorinated) vinyl chloride copolymer resin has molecular weights greater than 150,000 daltons, and even more preferably greater than 175,000 daltons, and even greater than 200,000 daltons.

In certain embodiments, the DTS torque of a compound containing the (chlorinated) vinyl chloride copolymer resin in the 150,000 Mw category can be less than 5% reduced compared to the same compound containing CPVC or PVC homopolymer resin in the 150,000 Mw category, or in some cases less than 3%, or less than 1%. By “150,000 Mw category” it is meant to include Mw between 140,000 and 160,000. At the 175,000 Mw category, the DTS torque of a compound containing the (chlorinated) vinyl chloride copolymer resin can be from about 0.01% to about 15% reduced compared to the same compound containing a CPVC or PVC homopolymer resin in the 175,000 Mw category, or from about 0.5% to about 10% reduced, or from about 1% to about 8% reduced. By “175,000 Mw category” it is meant Mw between 160,000 and 180,000. At higher Mw categories, the DTS of the compound containing (chlorinated) vinyl chloride copolymer resin can be greater than 1%, 5%, or greater than 10%, or from about 1% to about 50% reduced compared to the same compound containing a CPVC or PVC homopolymer resin, or from about 5% to about 40% reduced, or from about 10% to about 30% reduced. More particularly, the DTS torque of a compound containing a (chlorinated) vinyl chloride copolymer resin as described herein will not increase at the same rate as the same compound containing a CPVC or PVC homopolymer resin, and preferably will stay steady or decrease, as the Mw of the resin increases.

In another aspect of the invention, the (chlorinated) vinyl chloride copolymer resins and (chlorinated) vinyl chloride copolymer compounds can be employed to provide improved chemical stability of an article in comparison to the same article made from a CPVC or PVC compound comprising a low Mw (chlorinated) vinyl chloride (co)polymer resin. “Chemical stability” refers to the article's ability to resist environmental stress cracking failures.

Resistance to environmental stress cracking can be determined according to ISO 22088 (equivalent to ASTM F2331). At a stress of 4000 psi with corn oil applied and at a temperature of 23° C., articles prepared from the compound comprising non-blended copolymer resin (“non-blended compound” i.e., the resin in the compound is more than 98% by weight the (chlorinated) vinyl chloride copolymer resin) can exhibit a time to failure (ttf) of at least 1.25 times the number of hours as exhibited by the same compound containing a CPVC or PVC homopolymer resin having an Mw of 150,000 daltons or less. In another embodiment, the non-blended compound can achieve at least 1.5 or at least 2 times the number of hours, and in another embodiment, it can achieve at least 2.5 or 3 times the number of hours to failure as exhibited by the same compound containing a CPVC or PVC homopolymer resin having an Mw of 150,000 daltons or less. In blended compounds, (i.e., compounds comprising both (chlorinated) vinyl chloride copolymer resin and low Mw (chlorinated) vinyl chloride (co)polymer resin) the effect of the low Mw resin will reduce the ESC ttf, but the blended compound will still be expected to exhibit a greater ttf due to the presence of the (chlorinated) vinyl chloride copolymer resin.

In another aspect of the invention the (chlorinated) vinyl chloride copolymer resins and (chlorinated) vinyl chloride copolymer compounds can be employed to maintain or improve impact strength as measured by the Izod or staircase methods. “Impact Strength” refers to the amount of force an article can withstand before fracturing. More specifically, the Izod impact test provides a laboratory measurement of the impact strength of a material by determining its maximum ability to absorb an impulse load, whereas the falling tup or staircase impact test provides a measurement of the impact strength for a material when extruded into pipe and encompasses both the material's impact strength and ductility.

Notably, the (chlorinated) vinyl chloride copolymer resins and compounds described herein can maintain suitable impact strength so as to maintain an article produced therefrom in the same class as if produced from the homopolymer. In fact, the (chlorinated) vinyl chloride copolymer resins and compounds can pass impact strength tests at Mw at which CPVC and PVC homopolymer resins and compounds cannot be processed.

Extrudate pipe and molded fittings for such pipe made using a (chlorinated) vinyl chloride copolymer compound of the present invention that has at least equivalent, if not better impact strength than a homopolymer compound, and improved chemical resistance provides considerable advantages to one constructing or maintaining, for example, industrial pipes. With maintained impact strength and improved chemical resistance, the compound can be employed to produce pipe that can withstand environmental stress factors for a longer period of time than standard pipe.

It is known that some of the materials described above may interact in the final formulation, so that the components of the final formulation may be different from those that are initially added. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### EXAMPLES

### DTS Examples

### Resins

A number of resins are tested at varying Mw. Two resins are evaluated for each Mw category and the average Cl % is provided in the table.

TABLE 1

| | % | Co- | % Co- | | |
|---|---|---|---|---|---|
| Sample | CPVC | monomer | monomer | Cl % | Mw |
| (control)1 | 100.0 | — | 0 | 66.7 | 117,000 |
| (control)2 | 100.0 | — | 0 | 66.7 | 146,000 |
| (control)3 | 100.0 | — | 0 | 66.6 | 166,400 |
| (control)4 | 100.0 | — | 0 | 66.6 | 191,500 |
| (control)5 | 100.0 | — | 0 | 66.6 | 310,900 |
| 6 | 98.4 | ethylene | 1.6 | 66.9 | 148,000 |
| 7 | 97.7 | ethylene | 2.3 | 66.8 | 173,600 |
| 8 | 97.8 | ethylene | 2.2 | 66.9 | 208,000 |
| 9 | 96.8 | ethylene | 3.2 | 66.7 | 291,200 |

### Compounds

Compounds for testing DTS are prepared according to the formulations in Table 2. Table 2 shows that compounds containing copolymer resins follow a trend of decreasing DTS as Mw increases whereas compounds containing homopolymer resins follow a trend of increasing DTS as Mw increases.

Table 2 also shows that Izod impact strength of the compounds containing the copolymers are at least maintained and trend to improvement compared to compounds containing homopolymer as Mw increases above 150,000.

TABLE 2

| | Comp Ex. 1 | Ex. 1 | Comp Ex. 2 | Ex. 2 | Comp Ex. 3 | Ex. 3 | Comp Ex. 4 | Ex. 4 |
|---|---|---|---|---|---|---|---|---|
| | Sample 2 | Sample 6 | Sample 3 | Sample 7 | Sample 4 | Sample 8 | Sample 5 | Sample 9 |
| Parts Resin | 100 | 100 | 100 | 100 | 100 | 100 | 100 | 100 |
| Stabilizers | 2.65 | 2.65 | 2.65 | 2.65 | 2.65 | 2.65 | 2.65 | 2.65 |
| Impact Modifier | 9 | 9 | 9 | 9 | 9 | 9 | 9 | 9 |
| Lubricant | 2.25 | 2.25 | 2.25 | 2.25 | 2.25 | 2.25 | 2.25 | 2.25 |
| Package | | | | | | | | |
| Filler | 4 | 4 | 4 | 4 | 4 | 4 | 4 | 4 |
| DTS-torque | 3585 | 3576 | 3717 | 3422 | 3934 | 3541 | 4176 | 3212 |
| % reduction | 0.2% | | 7.9% | | 10.0% | | 22.9% | |
| DTS | | | | | | | | |
| Izod Impact (ft- | 14.7 | 13.6 | 14.5 | 13.3 | 13.4 | 14.0 | 11.3 | 12.2 |
| lbs) | | | | | | | | |
| Staircase (ft- | 20/42 | 21/46 | — | 17/33 | 5/20 | 9/20 | Cannot | 8/10 |
| lbs) 30° F./73° F. | | | | | | | extrude | |

DTS-torque method—Using a Brabender with a mixing head, a compound is added to the machine at 205-210° C. and the torque and temperature are measured over time. The torque rises quickly to a maximum for the fusion peak and then drops and maintains a median torque until the resin degrades to a point when it starts to crosslink. After the torque rises 100 meter-grams above the minimum torque, the stability time is taken.

Izod impact strength method—Plaques are prepared from the sample compound and ¼ or ⅛ inch thick samples are cut and grooved. A pendulum that is weighted is released and strikes the notch. The results are measured as foot pounds of force required to break or partially break the bar.

Staircase method—the sample compounds are extruded into pipe. A weight is held a predetermined distance above the pipe and allowed to drop on the pipe. The results are measured as foot pounds of force required to break or partially break the pipe.

### ESC Examples

Compounds for ESC-ttf are prepared according to the formulations in Tables 4 and 5.

TABLE 4

| | | Comp Ex. 5 | Ex. 5 | Ex. 6 | Ex. 7 | Ex. 8 |
|---|---|---|---|---|---|---|
| | | Sample 2 | Sample 6 | Sample 7 | Sample 8 | Sample 9 |
| Parts | Resin | 100 | 100 | 100 | 100 | 100 |
| | Stabilizers | 2.4 | 2.4 | 2.4 | 2.4 | 2.4 |
| | Impact Modifier | 8 | 8 | 8 | 8 | 8 |
| | Lubricant Package | 2.25 | 2.25 | 2.25 | 2.25 | 2.25 |
| | Filler | 4.01 | 4.01 | 4.01 | 4.01 | 4.01 |
| | DTS-torque, mg | 3115 | — | 3129 | 3411 | 3484 |
| | Notch Izod Impact (ft-lbs) | | | | | |
| | Tensile Strength, psi | | | | | |
| | Tensile Modulus, kpsi | | | | | |
| | Heat Deflection Temperature, F. | | | | | |
| | ESC-ttf (times better than control) | 1.0 | — | 1.89 | 3.12 | 3.75 |

ESC-ttf method—Measured according to ISO 22088 with corn oil at a temperature of 23° C. and a stress of 4000 psi.

### Blended Compounds

A blended compound is prepared according to the formulations in Table 5.

TABLE 5

| | Comp Ex. 5 | Ex. 9 | Ex. 10 | Ex. 11 | Ex. 12 | Ex. 13 | Ex. 14 |
|---|---|---|---|---|---|---|---|
| Ingredients | Parts | Parts | Parts | Parts | Parts | Parts | Parts |
| Sample 1 | — | — | — | — | — | 50 | 50 |
| Sample 2 | 100 | 75 | 75 | 50 | 50 | — | — |
| Sample 7 | — | 25 | — | — | — | — | — |
| Sample 8 | — | — | — | 50 | — | 50 | — |
| Sample 9 | — | — | 25 | — | 50 | — | 50 |
| Stabilizers | 2.4 | 2.4 | 2.4 | 2.4 | 2.4 | 2.4 | 2.4 |
| Impact Modifier | 8 | 8 | 8 | 8 | 8 | 8 | 8 |
| Lubricant Package | 2.25 | 2.25 | 2.25 | 2.25 | 2.25 | 2.25 | 2.25 |
| Filler | 4.01 | 4.01 | 4.01 | 4.01 | 4.01 | 4.01 | 4.01 |
| DTS-torque, mg | 3115 | 3176 | 3298 | 3573 | 3676 | 3221 | 3608 |
| Notch Izod Impact | | | | | | | |
| (ft-lbs) | | | | | | | |
| Tensile Strength, psi | | | | | | | |
| Tensile Modulus, | | | | | | | |
| kpsi | | | | | | | |
| Heat Deflection | | | | | | | |
| Temperature, F. | | | | | | | |
| ESC-ttf (hours) | 1.0 | 1.16 | 1.44 | 1.41 | 1.52 | 1.31 | 1.63 |

ESC-ttf method—Measured according to ASTM 2293 with corn oil at a temperature of 23° C. and a stress of 4000 psi.

Each of the documents referred to above is incorporated herein by reference. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

What is claimed is:

1. An extruded pipe comprising a compound comprising a (chlorinated) vinyl chloride copolymer resin comprising a major portion of vinyl chloride monomer and a minor portion of a vinyl component co-monomer, wherein said (chlorinated) vinyl chloride copolymer resin has a weight average molecular weight of greater than 150,000 daltons.

2. The extruded pipe of claim 1, wherein said vinyl component comonomer is selected from ethylene, propylene, isobutylene, or mixtures thereof.

3. The extruded pipe of claim 1, wherein the co-monomer is present at from about 0.01% to about 10% of the total monomers in the (chlorinated) vinyl chloride copolymer resin.

4. The extruded pipe of claim 1 wherein the resin has a chlorine content of between about 57 wt. % and 70 wt. %.

5. The extruded pipe of claim 4, wherein the resin is a UV-chlorinated resin.

6. (canceled)

7. (canceled)

8. The extruded pipe of claim 1, wherein the compound additionally comprises a low Mw (chlorinated) vinyl chloride (co)polymer resin having an Mw of 150,000 daltons or less in a blend with the (chlorinated) vinyl chloride copolymer resin, and wherein the average Mw of the resin blend is greater than 150,000 daltons.

9. The (chlorinated) vinyl chloride compound of claim 8, wherein the ratio of the (chlorinated) vinyl chloride copolymer resin to the low Mw (chlorinated) vinyl chloride (co)polymer resin is greater than 1:4.

10. (canceled)

11. A method of imparting processability to a (chlorinated) vinyl chloride polymer resin having an Mw of greater than 150,000 daltons comprising preparing the (chlorinated) vinyl chloride polymer resin from vinyl chloride co-monomer and ethylene co-monomer, wherein the ethylene co-monomer comprises from about 0.01% to about 8% of the co-monomers in the vinyl chloride copolymer resin, and optionally post-chlorinating the resultant polymer.

12. A method of providing an article having improved chemical stability compared to the same article prepared from CPVC or PVC compound having an Mw of less than 150,000 daltons, comprising employing in the CPVC or PVC compound at least 78 wt. % of a (chlorinated) vinyl chloride copolymer resin comprising a major portion of vinyl chloride monomer and a minor portion of a vinyl component co-monomer, wherein said (chlorinated) vinyl chloride copolymer resin has a weight average molecular weight of greater than 150,000 daltons.
